(19) United States
(12) Patent Application Publication
(10) Pub. No.: US 2019/0169807 A1
(43) Pub. Date: Jun. 6, 2019

(54) TRAFFIC CONE HOLDER

(71) Applicant: JEFFERY QUEEN, SEAMAN, OH (US)

(72) Inventor: JEFFERY QUEEN, SEAMAN, OH (US)

(21) Appl. No.: 15/831,386

(22) Filed: Dec. 4, 2017

(51) Int. Cl. E01F 9/70; F16M 13/02; F16M 11/00

(52) U.S. Cl. CPC E01F 9/70; F16M 11/00; F16M 13/02

(57) ABSTRACT

A traffic cone holder that includes: a mounting base, where the mounting base is adapted to mount to a flat surface; a means to secure the mounting base in a stationary position; a vertical connection tube extending from the mounting base; and a receiving stem connected to the vertical connection tube at an adjoining end of the receiving stem, wherein the receiving stem extends horizontally from the vertical connection tube. The vertical connection tube extends at a length to create space between the mounting base and receiving stem. The means to secure includes a plurality of bolts. The traffic cone holder may also include a first gusset between the mounting base and the vertical connection tube; and a second gusset between the vertical connection tube and receiving stem.

### BACKGROUND OF THE INVENTION

### Field of Invention

The present invention relates to a traffic cone holder that is used to hold a series of traffic cones in a stationary position.

### Description of Related Art

Traffic cones are used by many workers to warn drivers and pedestrians of construction or simply to zone off a particular area for a particular period of time. The average traffic cone is about 2 feet high and normally made of plastic and rubber material. Various construction workers, safety people, utility workers, police and firemen all use traffic cones to control traffic flow as needed. The traffic cone is normally placed on the ground and manually handled by the user. Workers must carry these cones in order to have them available for their particular job. The cones are usually stacked however stacking the cones may be impractical in certain vehicles or vans. Further, the stacking of the cones occupy space that could be utilized for other equipment. As a result, it would be advantageous to have any type of mounting device that could mount and hold a series of traffic cones as needed.

### SUMMARY OF THE INVENTION

The present invention relates to a traffic cone holder that includes: a mounting base, where the mounting base is adapted to mount to a flat surface; a means to secure the mounting base in a stationary position; a vertical connection tube extending from the mounting base; and a receiving stem connected to the vertical connection tube at an adjoining end of the receiving stem, wherein the receiving stem extends horizontally from the vertical connection tube. The vertical connection tube extends at a length to create space between the mounting base and receiving stem. The means to secure includes a plurality of bolts. The traffic cone holder may also include a first gusset between the mounting base and the vertical connection tube; and a second gusset between the vertical connection tube and receiving stem.

### BRIEF DESCRIPTION OF DRAWINGS

FIG. 1 depicts a traffic cone holder in accordance with the present invention.

### DETAILED DESCRIPTION

The present invention relates to a traffic cone holder that is mounted on a flat surface. Preferably the holder is mounted on the ceiling of an enclosed vehicle such as a van or utility truck. Once mounted the cones may be stacked on a receiving stem that extends horizontally and is connected to a vertical tube that extends from the base of the holder. The base is mounted to the flat surface or interior roof of the vehicle.

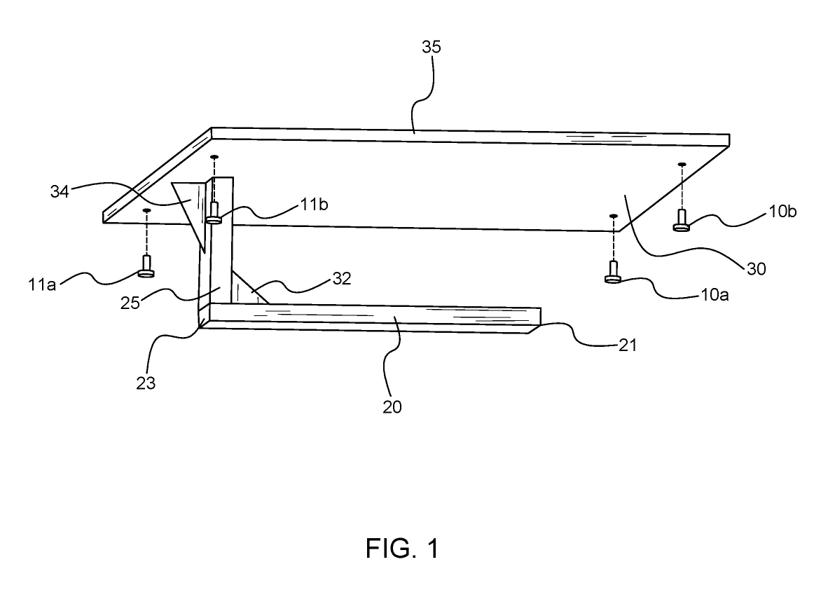

A traffic cone holder is depicted in FIG. 1 according to the present invention. This traffic cone holder includes a Base 30 that is a substantially flat surface with a series of receiving holes for mounting purposes. As shown in FIG. 1, mounting holes are placed in each corner of the substantially rectangular base. Within the holes, bolts 10a, 10b, 11a, 11b are inserted to secure the base to place. At one end of the base 30 is a vertical tube 25. This vertical tube 25 is connected to the base 30 and receives a horizontal receiving stem 20 at the distal end thereof. The receiving stem 20 adjoins with the vertical tube 25 at a proximal end 23. The receiving stem 20 that allows for the mounting of traffic cones on thereto. The vertical tube 25 extends vertically to allow sufficient space between the receiving stem 20 and mounting base 30. Once on the stem 20 the cone is secured in place. The features of the traffic cone holder include the bolts 10a, 10b, 11a, 11b, which extend through the respective receiving holes to mount the base 30 in a stationary position. The base 30 has a mounting surface 35 opposite to the opposing surface that receives the vertical tube 25.

A first gusset 34 is connected between the base 30 and vertical tube 25. This gusset 34 provides a stabilizing feature to stabilize the tube 25 in its vertical position. A second gusset 32 is provided between the vertical tube 25 and receiving stem 20 to stabilize this connection between these two components. Once in place traffic cones may be easily stacked onto the stem 20 at a distal end 21.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

1. A traffic cone holder comprising:
a. a mounting base, where the mounting base is adapted to mount to a flat surface;
b. a means to secure the mounting base in a stationary position;
c. a vertical connection tube extending vertically at a right angle from the mounting base;
d. a receiving stem connected to and extending horizontally from the vertical connection tube at an adjoining end of the receiving stem, wherein the receiving stem extends horizontally from the vertical connection tube;
e. a first gusset between the mounting base and the vertical connection tube, where the first gusset provides a stabilizing feature to stabilize the vertical connection tube in a vertical position; and
f. a second gusset between the vertical connection tube and receiving stem, wherein the second gusset stabilizes a connection between the vertical connection tube and the receiving stem.

2. The traffic cone holder according to claim 1, wherein the vertical connection tube extends at a length to create space between the mounting base and receiving stem.

3. The traffic cone holder according to claim 1, where the means to secure includes a plurality of bolts.

4. (canceled)

5. (canceled)
